(19) United States
(12) Patent Application Publication
(10) Pub. No.: US 2026/0073227 A1
(43) Pub. Date: Mar. 12, 2026

(54) Using Generative Artificial Intelligence Systems To Create And Configure Policies In Enterprise Systems With Natural Language

(71) Applicant: Oracle International Corporation, Redwood Shores, CA (US)

(72) Inventors: Ramesh Thati, Hyderabad (IN); Thirupathi Reddy Samineti, Hyderabad (IN); Gopi Krishna Pandaraboina, Hyderabad (IN); Balaji Duvaragamani, Bengaluru (IN); Kavin Kumar Kuppusamy, Fremont, CA (US)

(73) Assignee: Oracle International Corporation, Redwood Shores, CA (US)

(21) Appl. No.: 19/194,457

(22) Filed: Apr. 30, 2025

Related U.S. Application Data
(60) Provisional application No. 63/691,933, filed on Sep. 6, 2024.

(51) Int. Cl. G06N 3/0895

(52) U.S. Cl. CPC G06N 3/0895

(57) ABSTRACT

At least one non-transitory computer readable media storing instructions that, when executed by one or more hardware processors, causes performance of operations. The operations include receiving a natural language query defining a policy for a workflow. The operations also include retrieving supplementary information relevant to at least one of the workflow and the natural language query, wherein the supplementary information includes at least one code fragment. The operations further include building an input prompt for a large language model. The input prompt includes the natural language query and the supplementary information, and the input prompt directs the large language model to generate, based at least in part on the at least one code fragment, code that is executable to implement the policy for the workflow.

### INCORPORATION BY REFERENCE; DISCLAIMER

Each of the following applications are hereby incorporated by reference: Application No. 63/691,933 filed on Sep. 6, 2024. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to generative artificial intelligence systems and methods, and in particular, techniques for creating and configuring policies in enterprise systems with natural language using large language models.

### BACKGROUND

Enterprise systems encompass large-scale application software solutions designed to support and integrate business processes, information flows, reporting, and data analytics in complex organizations. Enterprise systems may enhance organizational efficiency, improve decision-making, and ensure different parts of an organization work together seamlessly. Example enterprise software technologies include enterprise resource planning (ERP), customer relationship management (CRM), supply chain management (SCM), business intelligence (BI), and enterprise asset management (EAM) systems. These systems are often interconnected, providing a comprehensive view and control over an organization's operations.

Enterprise systems generally allow users to define custom rules or policies to tailor the system's functionality, security, and compliance measures to meet specific organizational requirements. The rules and policies may help standardize processes, ensure security, and maintain data integrity across an enterprise's computing infrastructure. Deploying custom rules often relies on the expertise of information technology (IT) professionals or administrators that understand the technical intricacies of an enterprise system to properly configure settings, permissions, and workflows. In many cases, the customization tools rely on scripting languages to create and enforce custom rules and policies, such as access control configurations, data retention scripts, and security protocols. As a result, individuals with limited technical training are often not able to quickly deploy new or updated policies within an enterprise system. Frequent back-and-forth communication between enterprise users and technical support teams may lead to significant delays in rule implementation and testing.

Even with the support of an IT professional, the process of configuring and maintaining a policy can be a cumbersome and error-prone process due to the scale and complexity of modern-day enterprise system application software packages. As rules grow in complexity, understanding and maintaining policies can become a challenge. Small changes may require technical intervention, increasing the cost and time of maintenance. Additionally, manual testing of rules against a broad range of test data is slow, prone to human error, and requires significant effort to ensure accuracy and prevent overage. Lack of immediate validation may lead to errors in the rule logic that might not be discovered until late in the development process and, in some cases, after the rules have already been gone live within production environments.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a prompt generation and rule validation system 100 in accordance with one or more embodiments;

FIG. 2 illustrates an example set of operations 200 for using large language models (LLMs) to generate and configure policies within enterprise systems in accordance with some embodiments;

FIG. 3 illustrates an example of a prompt template in accordance with some embodiments;

FIGS. 4, 5, and 6 illustrates an example set of contextual information in accordance with some embodiments;

FIG. 7 illustrates an example prompt at runtime in accordance with some embodiments;

FIG. 8 illustrates an example user interface for submitting requests for creating a new policy or policies using generative artificial intelligence in accordance with some embodiments;

FIG. 9 illustrates an example user interface for managing automatically generated policies in accordance with some embodiments;

FIG. 10 illustrates an example user interface for uploading a policy document in accordance with some embodiments;

FIG. 11 illustrates an example user interface for uploading and extracting multiple policies from a file in accordance with some embodiments;

FIG. 12 illustrates an example user interfaces for uploading, adding, deleting, and review/editing single or multiple policies from a file in accordance with some embodiments;

FIG. 13 illustrates an example text file of a policy document in accordance with some embodiments; and

FIG. 14 illustrates a computer system in accordance with some embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present invention.
1. GENERAL OVERVIEW
2. PROMPT GENERATION AND RULE VALIDATION SYSTEM
3. RULE GENERATION AND VALIDATION USING GENERATIVE ARTIFICIAL INTELLIGENCE
4. EXAMPLE IMPLEMENTATION AND USER INTERFACES
5. COMPUTER NETWORKS AND CLOUD NETWORKS
6. HARDWARE OVERVIEW
7. MISCELLANEOUS; EXTENSIONS

### 1. General Overview

Embodiments herein use artificial intelligence (AI) services to streamline the process of rule creation and validation within enterprise systems by allowing users to define policies in an unstructured, natural language format. The AI services automatically generate rules based on the provided natural language definitions and validate the rules against test data. The techniques reduce the need for technical expertise as users may intuitively create rules by specifying policy parameters in a natural language without needing any ability to code or having technical knowledge of the underlying enterprise system structure. As a result, rules may be deployed and updated within an enterprise system in a more efficient and cost-effective manner.

Embodiments herein formulate inputs to a large language model (LLM) using Retrieval-Augmented Generation (RAG) to ground the LLM's rule generation in sample data retrieved from external data sources. RAG may enhance the capabilities of generative models through integration with retrieval mechanisms that allow the models to generate more accurate, contextually-relevant outputs by leveraging external information during the rule generation process. When a user submits a natural language query (or policy document) defining a new policy (or policies) or a policy update (or policies update), a RAG process may use an encoded version of the query (or policy document) to search for and retrieve sample code fragments that provide example actions and/or conditions relevant to the natural language query (or policy document).

For efficient code and rule fragment retrieval, the documents in the RAG process are separated into distinct conditions and actions. This method has demonstrated higher accuracy when compared to the approach of using a document structure containing an entire business policy (both condition & action). The benefits of this approach are significant. One advantage is the ability to facilitate broader adoption across various enterprise software technologies, for example, ERP use cases. Additional benefits include: (i) support for the creation of complex condition patterns, (ii) support for the creation of complex action patterns, and (iii) clear segregation of conditions and actions, which minimizes confusion for the large language model (LLM). The fragments may be written using syntax, operators, functions, and/or expressions that are interpretable by an enterprise system's rule engine. The retrieved fragment(s) may then be passed along with an input prompt to the large language model (LLM). The supplemental information allows the large language model (LLM) to generate a rule that is grounded in current examples rather than a rule that is purely based on the model's internal knowledge or rule formats that are outdated.

Embodiments further add contextual information using prompt engineering instead of or in addition to using RAG. Prompt engineering involves designing and refining the input prompts given to the large language model (LLM) to guide the rule generation process. For example, prompt engineering may formulate a prompt using the natural language input and a prompt template that includes instructions, parameters, and/or constraints for generating a rule. The contextual information may define available and required structural elements of a rule such as the fields that are available or required within a rule block, a list of attributes from which the large language model (LLM) model may select, and routing information for sending messages. The model's responses using non-RAG contextual information are based on pre-trained knowledge rather than on information encoded in the prompt. A combination of RAG and non-RAG context provides a balance between grounding the rule generation in external data and pre-trained knowledge.

Embodiments herein automatically generate test data using an AI-based simulator. The AI-generated test data may encompass positive, negative, and corner cases to provide comprehensive testing of the AI-generated rule logic. Validation results may be generated by applying the AI-generated rules to the AI-generated test data and comparing the results with expected outcomes. The rules may be iteratively refined based on the validation results until the AI-generated rule logic meets the expected outcomes. The automated validation process may significantly reduce the amount of time and resources required to test newly created or updated rules. The process further reduces the risk of rule failures in production while allowing for new and updated rules to be more quickly deployed.

Embodiments herein allow users to generate and iteratively refine rules without requiring the users to manage underlying rule syntax, operator, functions, or expressions. The AI-generated validation results may be presented to the user in a natural language format that is intuitively easy to understand. If the AI-generated rules do not yield the expected outcomes, then the user may provide additional context, in an unstructured natural language format, to enhance rule generation. A generative large language model (LLM) may update the rules based on the additional context until the rules achieve the desired results. Technical users may also be provided with the ability to review and manually adjust the rules. For example, a user may directly edit the condition to manually adjust the rules.

Embodiments include receiving a natural language query (or policy document) that defines a policy (or policies) for a workflow and retrieving supplementary information relevant to at least one of the workflow and the natural language query (or policy document). The supplementary information includes at least one code fragment. Embodiments build an input prompt for a large language model (LLM). The input prompt includes the natural language query or policy document and the supplementary information. The input prompt directs the large language model (LLM) to generate, based at least in part on the at least one code fragment, executable rule to implement the policy for the workflow.

A natural language query or policy document may be a question(s) or request(s) written in an ordinary human language as opposed to a formal programming language or structured query language. A policy for a workflow refers to a set of guidelines, rules, or procedures that define how tasks, processes, or activities within a workflow should be executed. A workflow refers to a structured sequence of actions or processes to complete a particular task. A workflow defines how tasks move from start to finish, and a workflow policy governs how the workflow operates to ensure consistency, compliance, and efficiency in workflow execution.

In an enterprise system, for example, a workflow may include code for performing the actual sequence of actions to complete a task while a workflow policy may include code for ensuring workflow processes do not contravene policy rules and guidelines. For example, a procurement workflow may define an automated process for processing invoices associated with the procurement of goods and services. A procurement workflow policy may require that an invoice be approved by a department manager before being sent to the finance department for final review. If the invoice value exceeds a threshold amount, the policy may require additional approval from the director of finance, and the system may automatically send email notifications to users for each approval step. Workflow policy code may be implemented separately from workflow code to allow updates without modifying the entire workflow logic. However, the level of separation may vary from system to system.

An input prompt provides the large language model (LLM) with information that is used by the model to understand the context of the natural language query or policy document to assist in generating and outputting relevant executable rules to implement a policy for a workflow. In some embodiments, code that is executable to implement the policy for the workflow or executable code that is implemented by the policy for the workflow may also include interpretable code. Executable code may refer to a program that has been compiled into machine code, which can be directly executed by a computer's CPU without needing any further translation or interpretation. Compiling converts source code into executable code. Executable files typically have extensions like .exe, .out, .bin, etc. Interpretable code refers to a program written in a high-level programming language that requires an interpreter to execute it. An interpreter reads and executes the source code line-by-line or statement-by-statement at runtime, translating it into machine code as it goes. Thus, executable code may include machine code that is ready to run directly on a computer after being compiled or interpretable code that relies on an interpreter to translate the high-level code into machine code during execution. To this, the quality and clarity of the input prompt have a significant impact on the accuracy and utility of responses from the large language model (LLM).

In an embodiment, a user may enter in a natural language query or policy document to define a policy for a workflow. Then supplementary information, including a code fragment, relevant to the workflow and query or policy document may be retrieved so that an input prompt for a large language model (LLM) can be built. A code fragment refers to a piece of code that is part of a larger program or script. For example, a code fragment may include a condition, action, or both a condition and action that is not the entire program but rather a piece of the entire program. The input prompt will then be used by the large language model (LLM) to generate executable rule so that the policy for the workflow may be implemented. Thus, the user may generate rule to define the policy for the workflow of an enterprise system by using natural language. This allows individuals with limited technical training to quickly deploy new or updated policies within an enterprise system with the natural language query or policy document.

As an example, the user may enter in the natural language query (or policy document): Any invoice having an amount of or over one thousand dollars should be sent to the invoice creator. Next, supplementary information relevant to invoices and the query or policy document may be retrieved so that an input prompt for a large language model (LLM) can be built. The input prompt will then be used by the large language model (LLM) to generate executable rule so that invoices having an amount greater than or equal to 1000 will be sent to the invoice creator. This allows the user to deploy the policy within the enterprise system using natural language. As a result, users with limited technical training are able to quickly deploy new or updated policies within an enterprise system.

One or more embodiments described in this Specification and/or recited in the claims might not be included in this General Overview section.

### 2. Prompt Generation and Rule Validation System

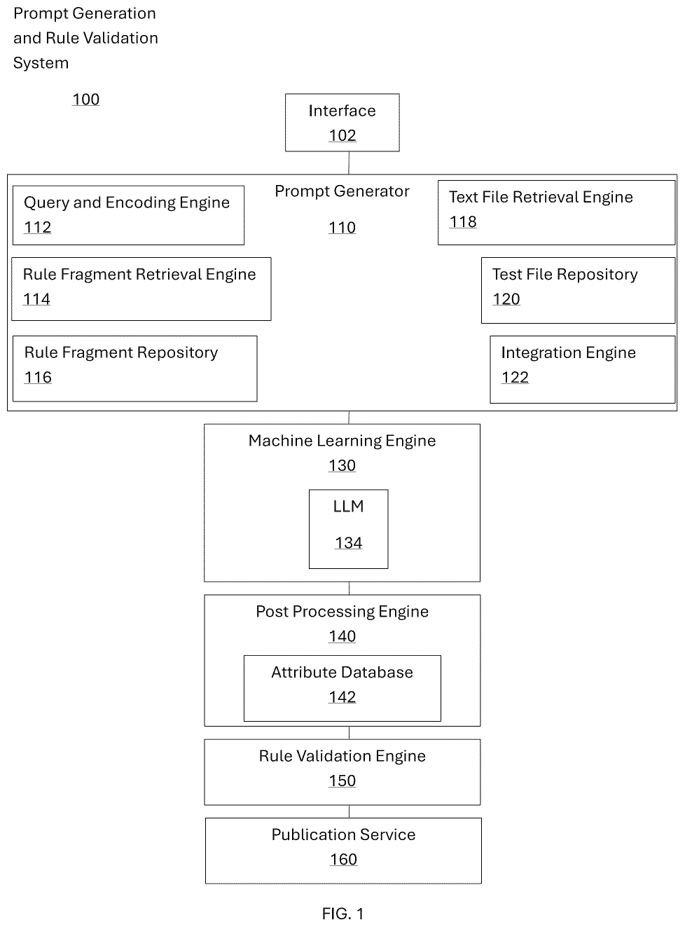

FIG. 1 illustrates a prompt generation and rule validation system 100 in accordance with one or more embodiments. As illustrated in FIG. 1, the system 100 includes an interface 102, prompt generator 110, machine learning engine 130, post processing engine 140, rule validation engine 150, and publication service 160. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The system 100 includes an interface 102 to allow a user to enter in a natural language query or policy document defining a policy or policies for a workflow. In one or more embodiments, the interface 102 refers to hardware and/or software configured to facilitate communications between a user and the system. Examples of interfaces include a graphical user interface (GUI), a command line interface (CLLI), a haptic interface, and a voice command interface. Examples of user interface elements include checkboxes, radio buttons, dropdown lists, list boxes, buttons, toggles, text fields, date and time selectors, command lines, sliders, pages, and forms.

The prompt generator 110, of the system 100, receives the natural language query or policy document from the interface 102 and retrieves supplementary information relevant to the workflow and the natural language query or policy document. Furthermore, the prompt generator 110 builds an input prompt including the natural language query or policy document and the supplementary information.

In an embodiment, the prompt generator 110 may include a query and encoding engine 112, a rule fragment retrieval engine 114, a rule fragment repository 116, a text file retrieval engine 118, a test file repository 120, and an integration engine 122.

In an embodiment, the query and encoding engine 112 includes hardware and/or software components for converting the natural language query or policy document into a numerical representation using an embedding model. In some embodiments, the numerical representations are vectors. The query and encoding engine 112 encodes the natural language query or policy document into a vector representation(s) to facilitate the capture of the semantic meaning of the natural language query or policies from the policy document and thus allows for quick retrieval of encoded documents from a vector database.

The rule fragment retrieval engine 114, in an embodiment, includes hardware and/or software components for calculating a similarity score between two vectors. The rule fragment retrieval engine 114 uses these scores to identify which vectors are similar to one another. For example, if the similarity score between two vectors is equal to or exceeds a threshold value then they are considered similar. The rule fragment retrieval engine 114 compares the numerical representations or vectors generated from the query and encoding engine 112 with vectors from a rule fragment repository 116.

In one or more embodiments, a rule fragment repository 116 is any type of storage unit and/or device (e.g., a file system, database, collection of tables, or any other storage mechanism) for storing rule fragments. Further, a rule fragment repository 116 may include multiple different storage units and/or devices. The multiple different storage units and/or devices may or may not be of the same type or located at the same physical site. Further, a rule fragment repository 116 may be implemented or executed on the same computing system as system 100. Additionally, or alternatively, a rule fragment repository 116 may be implemented or executed on a computing system separate from system 100. The rule fragment repository 116 may be communicatively coupled to system 100 via a direct connection or via a network. The rule fragment repository 116, may store samples of code fragments in a vectorized format. The rule fragment repository 116, may be partitioned to store condition rule fragments and action rule fragments.

The rule fragment retrieval engine 114 may, for example, retrieve the code fragments of the vectors from the rule fragment repository 116 that are similar to the vectors generated from the natural language query or policy document and provide this supplementary information to the machine learning engine 130 through an input prompt.

In an embodiment, the text file retrieval engine 118, of the prompt generator 110, includes hardware and/or software components for retrieving text files with relevant contextual information. In some embodiments, the text file retrieval engine 118 may retrieve a prompt template. The text file retrieval engine 118 may also retrieve supplementary information including, but not limited to, contextual information, a condition rule fragment, an action rule fragment, domain knowledge, general instructions, and/or schema instructions.

A text file repository 120, in an embodiment, may store the text files with relevant contextual information. The text file repository 120 may also store the prompt template(s) and supplementary information. The text file repository 120 is any type of storage unit and/or device (e.g., a file system, database, collection of tables, or any other storage mechanism) for storing rule fragments. Further, a text file repository 120 may include multiple different storage units and/or devices. The multiple different storage units and/or devices may or may not be of the same type or located at the same physical site. Further, a text file repository 120 may be implemented or executed on the same computing system as system 100. Additionally, or alternatively, a text file repository 120 may be implemented or executed on a computing system separate from system 100. The text file repository 120 may be communicatively coupled to system 100 via a direct connection or via a network.

In an embodiment, the integration engine 122 may include hardware and/or software components for adding the relevant contextual information and natural language query or policy document to the input prompt. In some embodiments, the integration engine 122 may add the supplementary information and natural language query or policy document to the input prompt.

The machine learning engine 130, in an embodiment, may include La large language model (LLM) 134. The machine learning engine 130 may include hardware and/or software components for retrieving the input prompt, including the natural language query or policy document and supplementary information, from the prompt generator 110.

In one embodiment, the LLM 134 generates rules based on the input prompt. In another embodiment, a language model (LM) generates rules based on the input prompt. The LM is an algorithm or model within software used to process the input prompt to predict the rule based on what the LM has learned. The LLM 134 is an algorithm or model within software used to process the input prompt to predict the rule based on what the LLM 134 has learned. An LLM is a type of language model that varies from a regular (non-large) language model in scale with respect to training and the model architecture. LLMs are typically trained on massive datasets with billions or more parameters. LLMs may be implemented using transformer architectures that process entire sequences in parallel using self-attention, whereas regular language models generally process data sequentially and have fewer neural network layers in the underlying model architecture. LLMs have broad knowledge across a variety of domains that are more versatile and robust than smaller language models. However, regular language models do not require as many resources and may run on smaller devices while being fine-tuned to perform domain-specific tasks.

In an embodiment, the post processing engine 140 includes an attribute database 142. The post processing engine 140 includes hardware and/or software components for performing post-processing on the code to check/correct for missing attributes. When generating the rule, the LLM 134 may incorrectly generate an attribute that prevents proper rule generation. The post processing engine 140 may obtain the incorrectly generated attribute from the attribute database 142. The attribute database 142 may store attributes used by the post processing engine 140 to correct for the incorrect attributes.

The rule validation engine 150, in an embodiment, includes hardware and/or software components for validating the rule after post-processing is completed by the post processing engine 140. The rule validation engine 150 may validate the rules against the expected outcomes in each test case and flag examples where the applied rule logic diverged from the expected outcome. The rule validation engine 150 may also perform a validation process on the code to determine whether or not the code satisfies validation criteria. If the validation criteria are not satisfied, then the rule validation engine with the LLM 134 refines the rule. If an attribute is missing then the LLM 134 may refine the code to correct for the missing attribute.

In an embodiment, the publication service 160 may publish the rule(s) within the enterprise system once the rules have been successfully validated by the rule validation engine 150. The publication service 160 integrates the code into the enterprise system to implement the policy for the workflow into one or more software applications of the enterprise system. Through the interface 102, the user can publish all the rules with the rule validation engine to an enterprise application in a single action.

### 3. Rule Generation and Validation Using Generative Artificial Intelligence

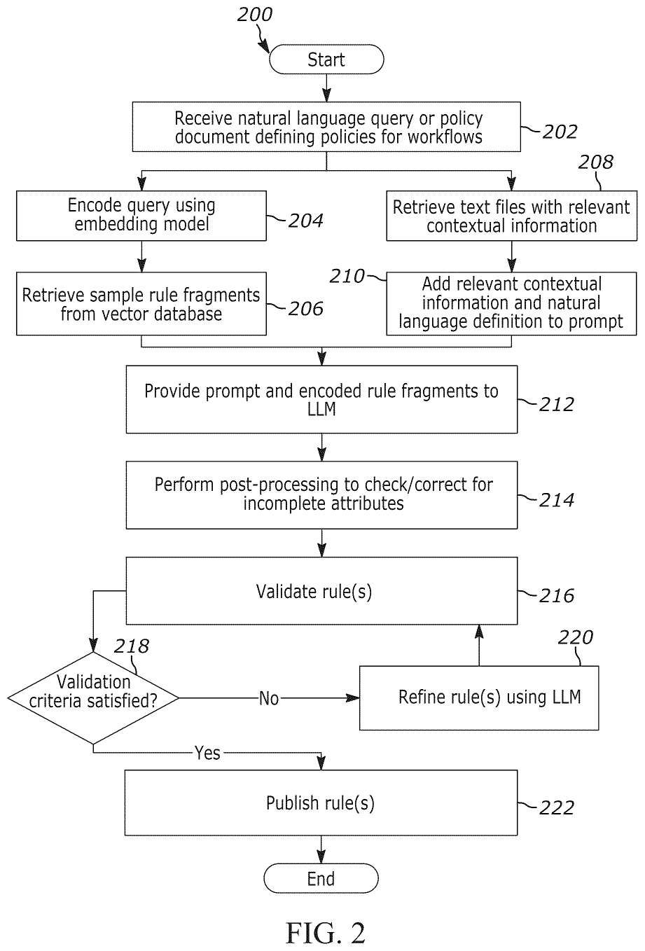

FIG. 2 illustrates an example set of operations 200 for using large language models (LLMs) to generate and configure policies within enterprise systems in accordance with some embodiments. One or more operations illustrated in FIG. 2 may be modified, rearranged, or omitted all together. Accordingly, the particular sequence of operations illustrated in FIG. 2 should not be construed as limiting the scope of one or more embodiments.

The process includes receiving a natural language query or policy document defining policies for a workflow (operation 202). A user may draft and submit, through a graphical user interface, a natural language query or policy document written in plain English or another natural language. The text may be unstructured without adhering to any predefined schema or following any specific format. For example, a user may submit the following natural language query defining a policy: All invoices that aren't matched to a purchase order require line manager approval. A user with no understanding of how purchase orders are structured, tracked, or otherwise managed by complex enterprise software systems may submit the user query or policy document. As natural language is nearly unbound, the queries and policies requested by a user are also nearly limitless. The process may use AI to automatically generate a rule that is interpretable/executable within the enterprise system even when the system has not previously encountered similar natural language queries.

Referring to FIG. 2, operation 204, the natural language query or policy document is converted into a numerical representation using an embedding model. An embedding model may be a type of machine learning model that transforms words into these numerical representations (often called embeddings). These embeddings may capture semantic relationships between words, meaning that words with similar meanings will have similar numerical representations. In some embodiments, the numerical representations are vectors. Also, when retrieving the supplementary information to the natural language query or policy document, at least one code fragment is retrieved from a database of code fragments encoded in the numerical representation based on a similarity threshold. A similarity threshold may be a cutoff value used to decide if two entities are considered similar. Based on a chosen similarity measure, if the similarity score between two items is equal to or exceeds the threshold, they are considered similar. If the similarity score between two items is below the threshold, they are considered dissimilar. The threshold helps automate the process of grouping, filtering, or comparing code fragments based on their similarity.

For example, responsive to receiving the natural language query or policy document, the process generates and augments an input prompt using external data retrieved using RAG, the text from the natural language query or policy document, and text from a set of predefined contextual information. The RAG process and prompt text generation may execute in parallel to increase efficiency. The RAG process encodes the natural language query using an embedding model (operation 204). In some embodiments, a word embedding model is used to encode the user query or policy document into a dense vector representation. Example embedding models include Bidirectional Encoder Representations from Transforms (BERT) and Distilled Bidirectional Encoder Representations from Transformers (DistilBert). However, the embedding model used to encode the user query or policy document may vary depending on the particular implementation. Encoding the natural language query or policy document into a vector representation captures the semantic meaning of the natural language query or policy document and allows for quick retrieval of encoded documents from a vector database.

Thus, the numerical representation of the natural language query or policy document may include a vector representation. Referring to FIG. 2, operation 206, the similarity threshold may include a Euclidean distance threshold value so that the at least one code fragment from the database is retrieved as supplementary information when the Euclidean distance between the vector representation of the natural language query or policy document and the vector representation of the at least one code fragment is less than the threshold value. A Euclidean threshold value refers to a specific cutoff or limit used in various algorithms or applications to determine how “close” or “similar” two points (or vectors) are to each other in a Euclidean space.

For example, the RAG process retrieves sample code fragments from a vector database (operation 206). In some embodiments, the vector database stores a large sample of code fragments in a vectorized format. The same embedding model applied to the natural language query or policy document may be applied to the code fragments to generate the vectorized representations of the rule fragments. The code fragments that are most semantically close may be determined by comparing the natural language query or policy document vector representation with the code fragment vector representations in the vector database. The number of code fragments that are retrieved for a given natural language query or policy document may vary from implementation to implementation. For example, the RAG process may retrieve the top n fragments for each natural language query. Additionally or alternatively, the RAG process may apply a similarity threshold where only code fragments that satisfy the threshold (e.g., the Euclidean distance is less than a threshold value) are retrieved. This allows for efficient rule fragment retrieval and facilitates broader adoption across various enterprise software technologies, for example, ERP use cases. Additional benefits include: (i) support for the creation of complex condition patterns, (ii) support for the creation of complex action patterns, and (iii) clear segregation of conditions and actions, which minimizes confusion for the large language model (LLM).

The code fragments may include at least one of a condition rule fragment and an action rule fragment. In some embodiments, code fragments may be partitioned or otherwise separated by category. For example, one partition or vector database may store condition code fragments, and another partition or vector database may store action code fragments. Action code fragments refer to samples of actions that a rule engine may execute within an enterprise system. Example actions may include updating a database, sending messages, enforcing security constraints, configuring access policies, and/or implementing other logic for performing an action related to a targeted workflow. Condition code fragments are sample code chunks of implementing and enforcing conditional logic, for example, a condition that when met, causes the execution of the action code fragment. In some embodiments, condition and action code fragments are similar to if/then statements. For example, if a condition is met, then an action is taken.

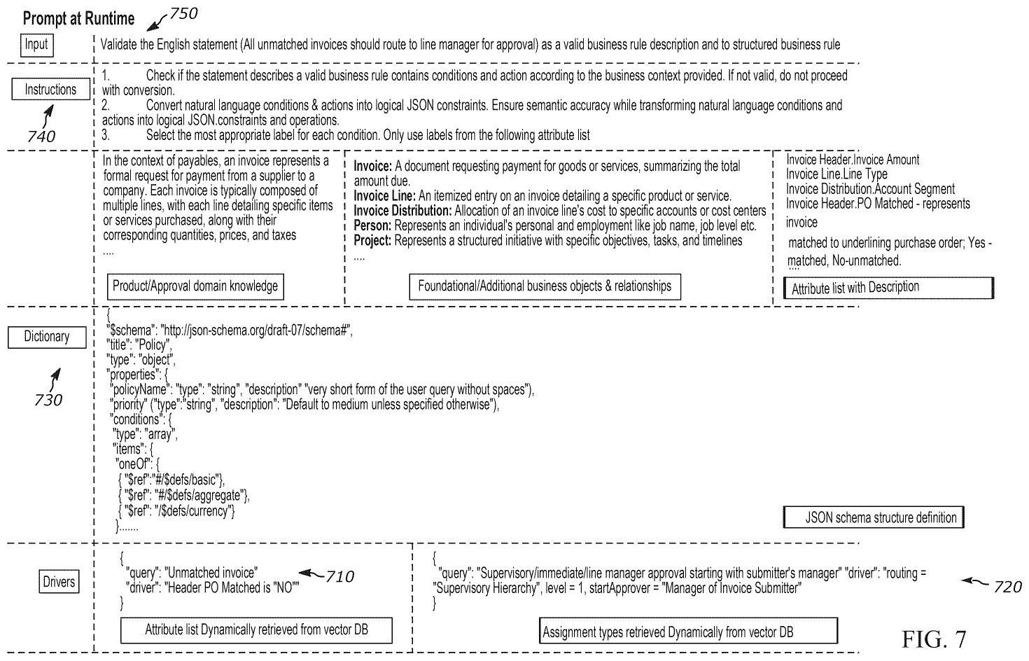

FIG. 7 illustrates an example set of a condition code fragment 710 and action code fragment 720 for an example prompt at runtime in accordance with some embodiments. Here, as indicated in the dictionary 730, at least one code fragment may conform to a JavaScript Object Notation (JSON) schema. As illustrated in FIG. 7, the condition code fragments 710 give examples of implementing different conditional statements according to the JSON format, and the action code fragments 720 give examples of implementing different actions. The code fragments provide examples of structure, syntax, operators, and expressions that are interpretable/executable by the rule engine in an enterprise system. Although the examples herein follow JSON, the format may vary depending on the particular implementation. For instance, the rules may be defined according to other markup language and/or scripting language formats. Again, this contributes to efficient rule fragment retrieval and facilitates broader adoption across various enterprise software technologies, for example, ERP use cases. Additional benefits include: (i) support for the creation of complex condition patterns, (ii) support for the creation of complex action patterns, and (iii) clear segregation of conditions and actions, which minimizes confusion for the large language model (LLM).

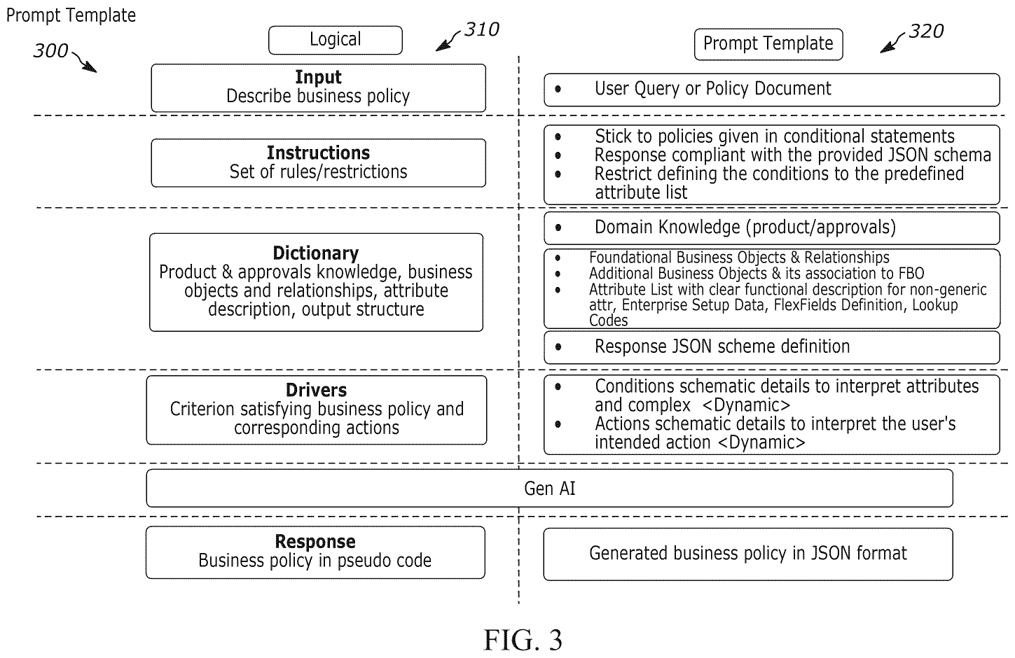

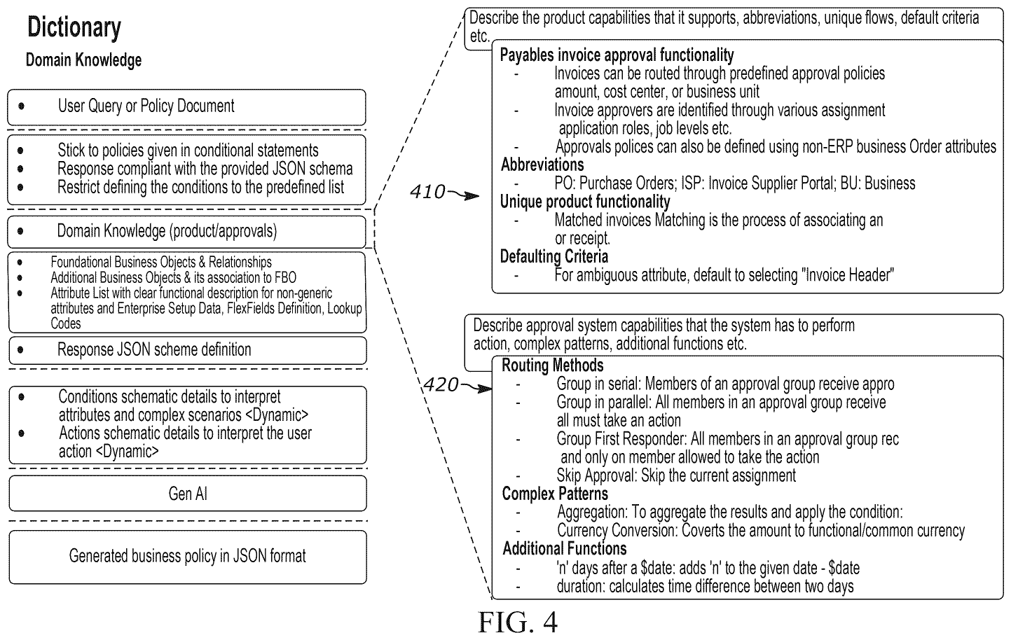

Referring again to FIG. 2, the prompt engineering process retrieves text files with relevant contextual information (operation 208). In some embodiments, the process retrieves a prompt template used to generate an input prompt for a large language model (LLM). The prompt template may be populated with supplementary information. In some embodiments, the supplementary information may include, but is not limited to, at least one of contextual information, at least one condition rule fragment, an action rule fragment, domain knowledge, general instructions, and schema instructions. For example, referring to FIG. 3, an example of a prompt template 300 is shown alongside a logical indication of the different fields within the prompt template. The left column 310 indicates the logical indication of the information used to populate the prompt template. The right column 320 indicates the specific information called for by the prompt template. For example, logically the process calls for an input that describes the business policy. The actual input that's shown on the right is the natural language query or policy document entered by the user. In an embodiment, the user query may be replaced with a policy document for entering in multiple policies. Also, after entering in multiple policies through the use of a policy document including multiple policies, the input can also accept a natural language query to update a policy already entered in by the policy document or add an additional policy that was not initially entered in by the policy document. Additionally, the prompt template may be populated with the output structure defining the schema for a policy to be generated by a large language model (LLM). For example, the business policy may be generated in JSON format. Domain knowledge, logically associated with dictionary in the left column 310, may refer to the understanding and context of specific fields, topics, or industries that a large language model (LLM) can leverage to generate relevant and accurate responses. An example of domain knowledge is found in FIG. 4. General instructions define what task to perform and associated constraints such as sticking to the policies given in conditional statements and ensuring the response is compliant with the provided schema and drafting conditions. Schema instructions may be guidelines or formal specifications that define the structure and organization of data in a given system or application. Schema instructions can be, but are not limited to, data formats like JSON/XML (schema definitions), machine learning data pipelines, configuration files, or semantic web technologies, depending on the context. The purpose is to ensure that data is structured in a way that can be consistently processed and validated. In this way, the code fragment retrieved can have the particular schema found defined in the schema instructions. As such, the input prompt may direct the large language model (LLM) to generate the code to implement the policy according to the particular schema found in the schema instructions. Thus, retrieval of the supplementary information may include using a schema driver to select a particular schema from a plurality of schemas. By providing the user the ability to select a particular schema, users can define custom rules or policies using different data formats. This allows the user to define custom rules or policies for a multitude of enterprise systems without the need for IT professionals or administrators that understand the technical intricacies of an enterprise system to properly configure settings, permissions, and workflows. The process may further retrieve contextual information to populate the prompt template, such as information about the enterprise system, including routing types, rule structures, operators, and a list of attributes from which to choose. Generally, a workflow is a repeatable set of actions that can be procedurally executed to accomplish a specific goal. Some examples of workflows in enterprise systems may be: Employee on-boarding, Expense report management, etc. As such, all the actions or rules may be selected by the type of workflow being performed. For example, depending on the type of workflow, the actions and rules selected may be based on one of expenses, procurements, or invoices etc. As such, contextual information related to the workflow will determine what text files the prompt engineering process retrieves. Also, the type of prompt template retrieved, and that is to be populated with the contextual information, is specific to the type of workflow. However, the output structure defined in the prompt template (e.g., the type of schema) might not be dependent on the type of workflow. Additionally, query matching documents defined in the prompt template might not be dependent on the type of workflow. General instructions, however, that are dependent on the type of workflow may be retrieved to populate the prompt template. These general instructions may be commands on how the large language model (LLM) is to react. For example, the general instructions may include instructing the large language model (LLM) to generate the schema in a chosen format. As seen in FIG. 7, in an embodiment, the instructions 740 here instruct the large language model (LLM) to generate the schema in the JSON format. For example, the instructions may include instructing the large language model (LLM) to generate conditions using a predefined list of attributes based on the type of workflow chosen. In this embodiment, the type of workflow chosen is assumed by where the natural language query or policy document is invoked and not by the query itself or policy document itself, and as such, the predefined list of attributes associated with where the query or policy document was invoked determines what attributes are chosen for the list. For example, if the query or policy document was invoked in the context of expense policies, then the workflow chosen is expenses and the list of attributes retrieved for the tasks and instructions are the attributes associated with expenses. Additionally, domain knowledge may be retrieved to populate the prompt template. The domain knowledge is static content which may be the same for any type of workflow. The domain knowledge is independent of the type of workflow chosen, and thus, the same domain knowledge can be used for any type of workflow.

An example prompt template is illustrated in Table 1 below:

TABLE 1
[INPUT]
User Query/Policy Document
[TASK & INSTRUCTIONS]
Stick to policies given in conditional statements
Response compliant with the provided JSON schema
Restrict drafting the conditions to the predefined attribute list
[CONTEXT]
Domain knowledge (product/approvals)
Foundational business objects and relationships
Additional business objects & its association with foundational objects
Enterprise structure data, descriptive flex field data, lookup codes information
Attribute list with clear functional description for non-generic attributes
[QUERY MATCHING DOCUMENTS]
Relevant attributes/conditions retrieved dynamically from vector DB
Relevant assignment/action types retrieved dynamically from vector DB
[OUTPUT STRUCTURE]
JSON schema structure definition

As illustrated in Table 1, the prompt template includes segments that include the input where the natural language query is included, task/instruction descriptions, context, query matching documents, and the output structure schema. The input includes the text of the user query describing the policy rule to create. In one embodiment, the input includes the text of multiple user queries describing multiple policies to create. For example, a user interface may allow a user to upload a policy document including multiple policies. This may be done, for example, by uploading a single document (e.g., word processing document) including multiple policies. The task/instruction section defines what task to perform and associated constraints such as sticking to (i.e., adhering to) the policies given in conditional statements and ensuring the response is compliant with the provided schema and drafting conditions. The context section is populated with detailed information about the enterprise system including, for example, domain knowledge about the system, foundational business objects and relationships within the system, chart of account details, enterprise structure, descriptive flex field setup information and an available list of attributes that condition objects may include. The query matching documents include dynamic attribute list and assignment types extracted from the RAG documents. The output structure defines a JSON schema structure to which the response should adhere.

The example prompt structure may vary in order and/or elements. In other embodiments, one or more sections may be added and/or omitted. The sections may also vary in format. For example, the task instruction section may specify that the large language model (LLM) is to generate the rule only if supported by the context, which helps to reduce costs if a nonsensical user query is received. Other instructions/constraints may also be added to guide the large language model (LLM) in generating the rule for the given query input.

The prompt engineering process next adds the relevant contextual information and natural language query or policy document to the input prompt (operation 210). For example, the sections above may be populated with the natural language text of the user query or policy document and the contextual information retrieved about the enterprise system and rule format.

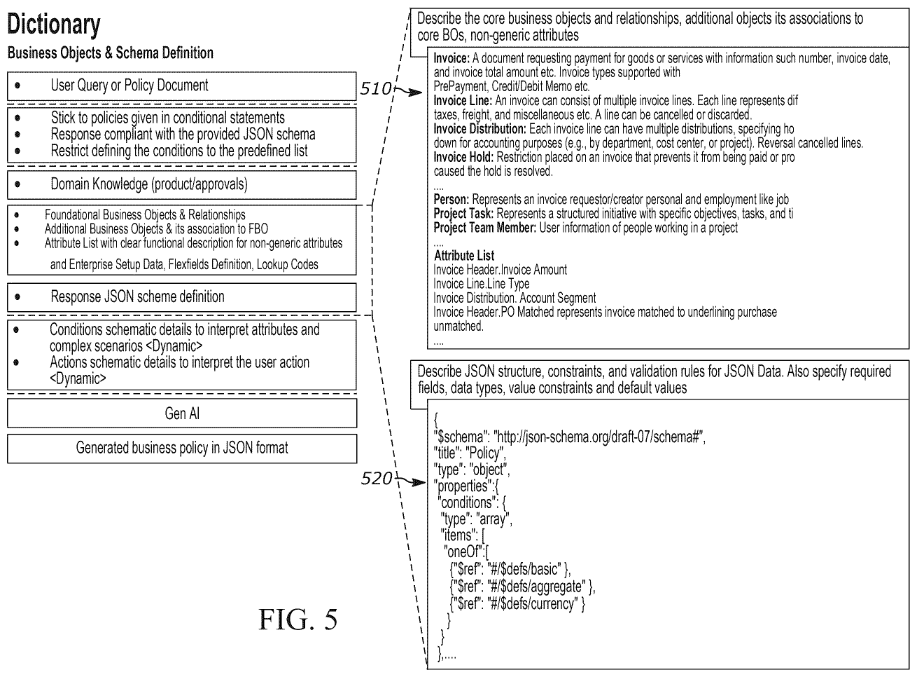

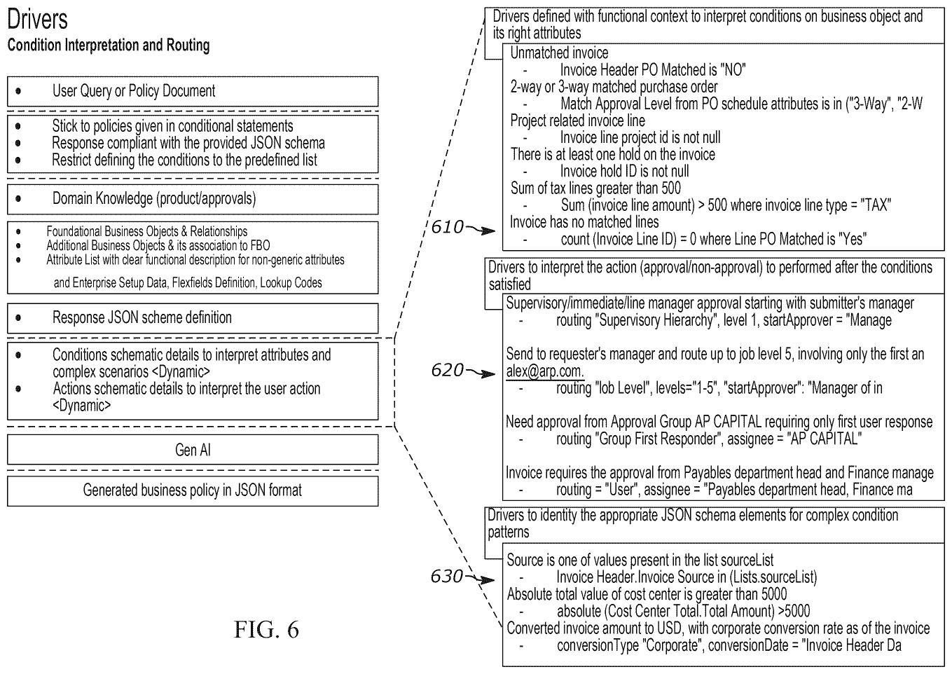

FIGS. 4, 5, and 6 illustrate an example set of contextual information in accordance with some embodiments. Referring to FIG. 4, the contextual information includes domain knowledge to guide the large language model (LLM)'s rule generation. For example, the domain knowledge describes the product capabilities 410 that it supports, abbreviations, unique product functionality and defaulting criteria. Furthermore, the domain knowledge describes the approval system capabilities 420 that the system has to perform action, complex patterns, and additional functions etc. FIG. 5 includes a description of the objects, relationships, and attributes. Plain text files may include the contextual information related to approvals, in the present example, and different routing types. The files include enterprise structure information including, for example, the chart of accounts details as well as descriptive flex fields defined in the system. The files also include business objects and attributes list understood by the system. For example, as indicated by 510, the business objects, relationships, additional objects and their associations to the business objects, as well as non-generic attributes are provided as contextual information. Furthermore, the response JSON scheme 520 definition describes the JSON structure, constraints, and validation rules for JSON Data. This also specifies the required fields, data types, value constraints and the default values as shown in FIG. 5. Referring to FIG. 6, for example, the contextual information includes driver information used to allow the drivers to interpret conditions 610 on business objects and its right attributes, determine the actions 620 to perform after the conditions are satisfied on the business objects, and information on the appropriate schema 630 to identify, for example, the appropriate JSON schema elements for complex condition patterns to provide to the large language model (LLM). The text in these documents are added to the final input prompt that goes to the large language model (LLM). In an embodiment, the prompt template may be populated with the contextual information from at least one test file. The prompt template may also be populated with the general instructions related to the workflow. Additionally, the prompt template may be populated with the output structure defining the schema for a rule generated by a large language model (LLM), and with domain knowledge independent of the workflow.

The input prompt is then built by combining the natural language query or policy document and the supplementary information. Subsequently, referring again to FIG. 2, the process provides the input prompt and encoded rule fragments to the large language model (LLM), for example but not limited to, the large language model (LLM) (operation 212). The encoded data grounds the outputs of the large language model (LLM) such that the large language model (LLM) uses the example syntax, structure, operators and expressions as a basis for generating the rules. The text of the prompt provides further guidelines for the large language model (LLM) model to follow, which may be based on its own learning while being grounded in the data retrieved from the external sources.

In an embodiment, a method includes the operations of receiving a natural language query defining a policy for a workflow or a policy document defining multiple policies for a workflow. The method also includes retrieving supplementary information relevant to at least one of the workflow and the natural language query or policy document, wherein the supplementary information includes at least one code fragment. The method further includes building an input prompt for a large language model (LLM), wherein the input prompt includes the natural language query or policy document and the supplementary information. The input prompt directs the large language model (LLM) to generate, based at least in part on the at least one code fragment, code that is executable to implement the policy for the workflow.

The process includes performing post-processing on the code to check/correct for incorrect attributes (operation 214). The output of a large language model (LLM) may, in some circumstances, generate an incorrect attribute that prevents proper rule interpretation/execution. In some embodiments, a default set of attribute values may be maintained and used to populate/finalize the large language model (LLM) generated rule.

Additionally or alternatively, other post-processing techniques may be applied to the large language model (LLM)-generated rule. For example, a large language model (LLM) may be tasked with correcting an incorrect attribute or otherwise refine a rule that is found to be deficient in some way. A prompt template may be used to cover these cases and submitted with the large language model (LLM) generated rule for refinement.

Once post-processing is complete, the process validates the AI-generated rule(s) (operation 216). In some embodiments, a large language model (LLM) is used to generate positive, negative, and corner test cases. In the example of an approval policy, for instance, the large language model (LLM) may generate test cases where approval is expected, not expected, and has a nonzero probability of both approval or disapproval. Additionally or alternatively, test data may be submitted, by an administrator or other user, with expected outcomes. The process may validate the rules against the expected outcomes in each test case and flag examples where the applied rule logic diverged from the expected outcome.

The process next determines whether a set of validation criteria are satisfied (operation 218). The validation process is performed on the code for determination on whether or not the code satisfies validation criteria. In some embodiments, the validation results are presented to an end user. The results may flag instances where the applied rule did not meet an expected outcome to highlight any potential deficiencies in the AI-generated rule. In other cases, the process may automate this step by determining whether the rule met the expected outcome within a threshold rate of accuracy.

If the validation criteria are not satisfied, then the process refines the rule(s) using the large language model (LLM) (operation 220). If an attribute is missing, then the large language model (LLM) may refine the code to correct for the missing attribute. The code may be iteratively sent back to the large language model (LLM) so that the large language model (LLM) may refine the code. For example, if the user does not accept the validation results, the user may input context, in a natural language, for the large language model (LLM) to refine the prompt. If the AI-generated rule unexpectedly granted approval for a test case, for instance, then the user may add conditions that were not specified in the initial user query or policy document to cover the scenario. In other cases, a large language model (LLM) model may be provided with a list of cases where the results were rejected, and the large language model (LLM) model may use such reinforcement feedback to iteratively refine the rule until it satisfies the validation criteria. The validation pipeline provides faster turnaround times compared to manual processes, improving system scalability and speed. In other cases, if an attribute is missing the large language model (LLM) may use a default attribute to correct for the missing attribute. For example, the default attributes for a large language model (LLM) may include characteristics, supplemental information, and behaviors that are applied to the input prompt when no specific information or settings are provided. These attributes govern how the model processes the input and generates the output. In some embodiments, when a missing attribute is detected, the large language model (LLM) may provide the missing attribute or refine the rules so the missing attribute is no longer needed.

Once the rule has been successfully validated, then the process publishes the rule(s) within the enterprise system (operation 222). As such, when the code has been validated by satisfying the validation criteria (operation 218) then the code is published (operation 222). In some embodiments, the enterprise system receives a response from the large language model (LLM) including the code for implementing the policy or policies for the workflow. The code is then integrated into the enterprise system to implement the policy for the workflow into one or more software applications of the enterprise system. In some embodiments, users can publish all the rules to an enterprise application in a single action. The application may provide a seamless deployment process where published rules are immediately available for execution, thereby facilitating efficient and reliable process automation.

### 4. Example Implementation and User Interfaces

FIG. 7 illustrates an example prompt at runtime in accordance with some embodiments. As illustrated, the user inputs 750 the natural language query (or policy document): All unmatched invoices should route to line manager for approval. Responsive to receiving the query or policy document, the system fetches the approval context from a set of text files, which includes details about the JSON structure, a list of attributes for the large language model (LLM) to use, and routing information. The RAG process retrieves relevant chunks from the vector database including a condition JSON rule fragment 710 and action JSON rule fragment 720 determined to be most semantically similar to the user query (or policy document) 750.

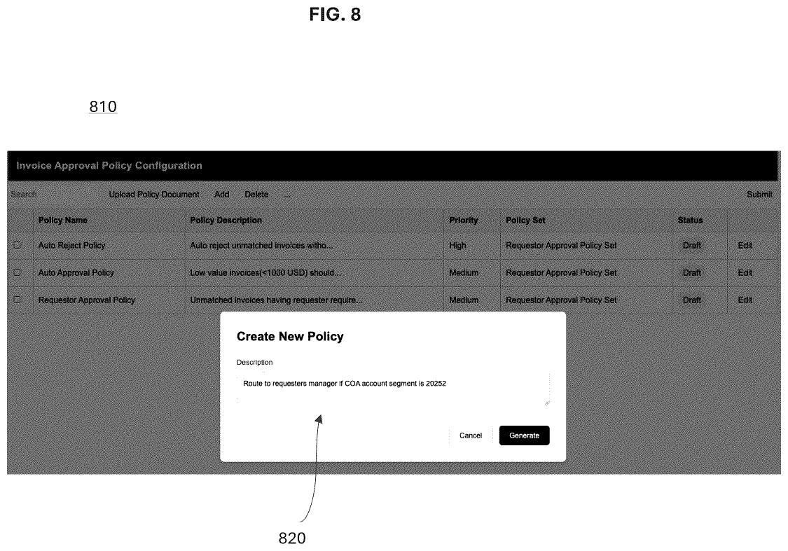

FIG. 8 illustrates an example user interface 810 for submitting requests for creating a new policy or policies using generative artificial intelligence in accordance with some embodiments. The user interface 810 allows the user to describe an invoice approval policy using natural language text 820. The system may provide similar interfaces for other types of policies, which may each be linked to different sets of contextual information used to create the large language model (LLM) input prompt. This interface also allows for the uploading of a policy document to create multiple invoice approval policies by simply uploading a single document including multiple policies (e.g., using a word processing document).

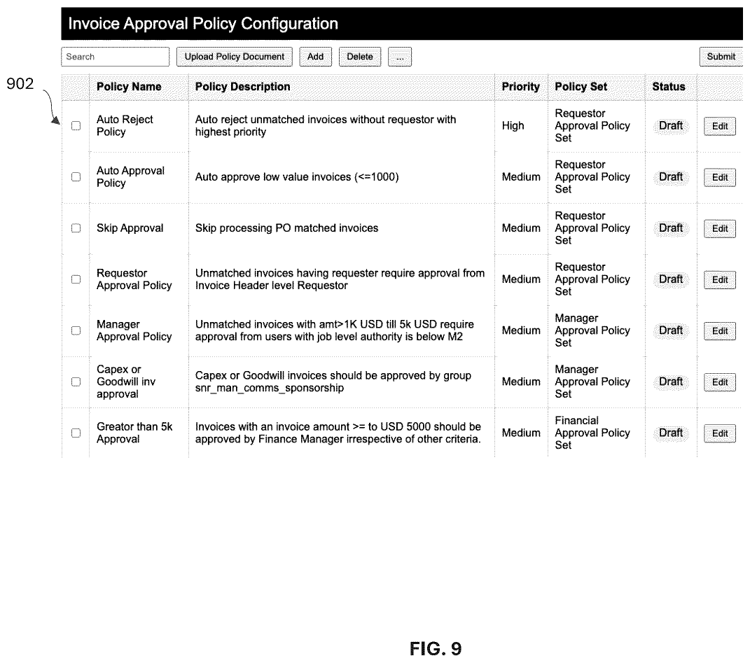

FIG. 9 illustrates an example user interface 900 for managing automatically generated policies (e.g., 902) in accordance with some embodiments. Submitted policies are processed in the backend by a generative AI with supplemental information, where it is generated and transformed into a standard format. The respective conditions and actions columns in the application table grid are automatically populated. Additionally, the administrator is allowed to modify the column values on top of the auto-generated policies if any changes are needed. The interface allows the user to publish all policies or select specific policies. Once published, the policies immediately go live in the relevant enterprise application(s) and are available for execution. Users may also use the interface to review and refine policies, either manually or using the generative AI techniques previously described. This interface also allows for the uploading of a policy document to create multiple invoice approval policies by simply uploading a single document including multiple policies (e.g., using a word processing document). In an embodiment, a policy can be edited one at a time by clicking the edit button for a particular policy (e.g., 902).

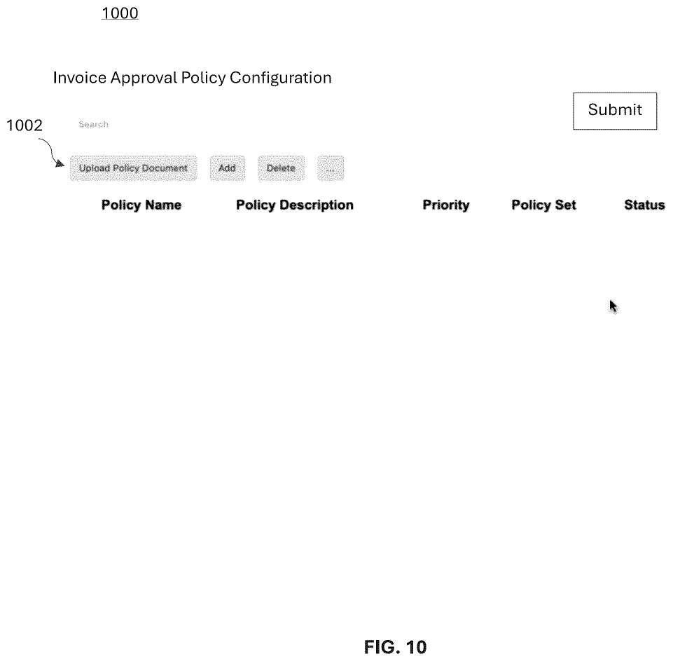

FIG. 10 illustrates an example user interface 1000 for submitting requests for generating multiple policies by providing the option to upload a policy document through policy document button 1002. The user interface 1000 allows the user to upload multiple policies by simply clicking buttons to add or delete policies. The policy document may be a single document (e.g., word processing document) that includes multiple policies that are input to the LLM. The LLM will generate all the conditions and actions for all the policies provided in the policy document (e.g., a single word processing document). By providing the user with the option to upload an entire document of polies, it allows the user to easily provide multiple polies through a first-time creation word document or policy document. Then the user can edit individual policies using a single query approach to upkeep the maintenance of the policy document. By providing the option to upload a policy document including multiple policies, the user can save time by not having to enter in the policies one by one.

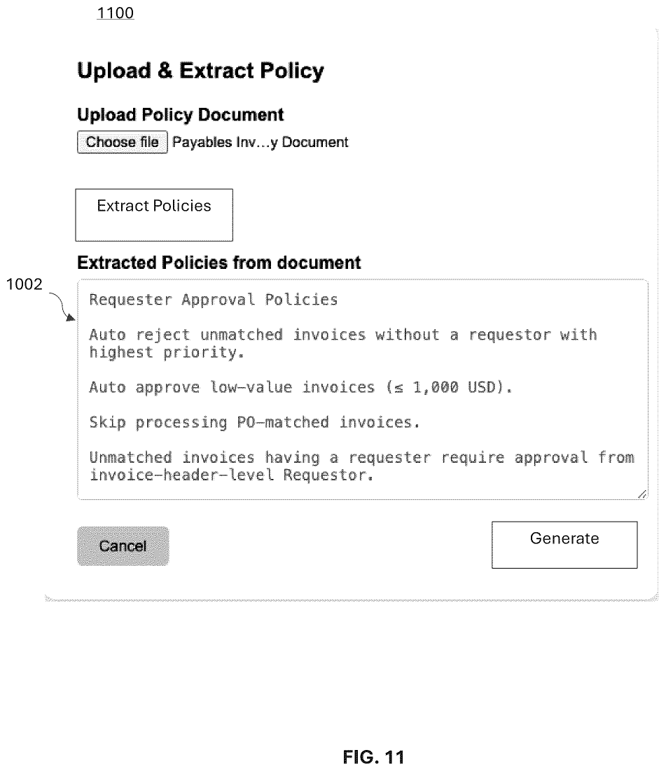

FIG. 11 illustrates an example user interface 1100 for uploading and extracting multiple policies from a file. After a file is chosen to upload and extract the policies from the user can see and review the extracted policies from the document 1002. Then the user can click the button generate so that the LLM can generate all the conditions and actions for all the policies provided in the uploaded policy document.

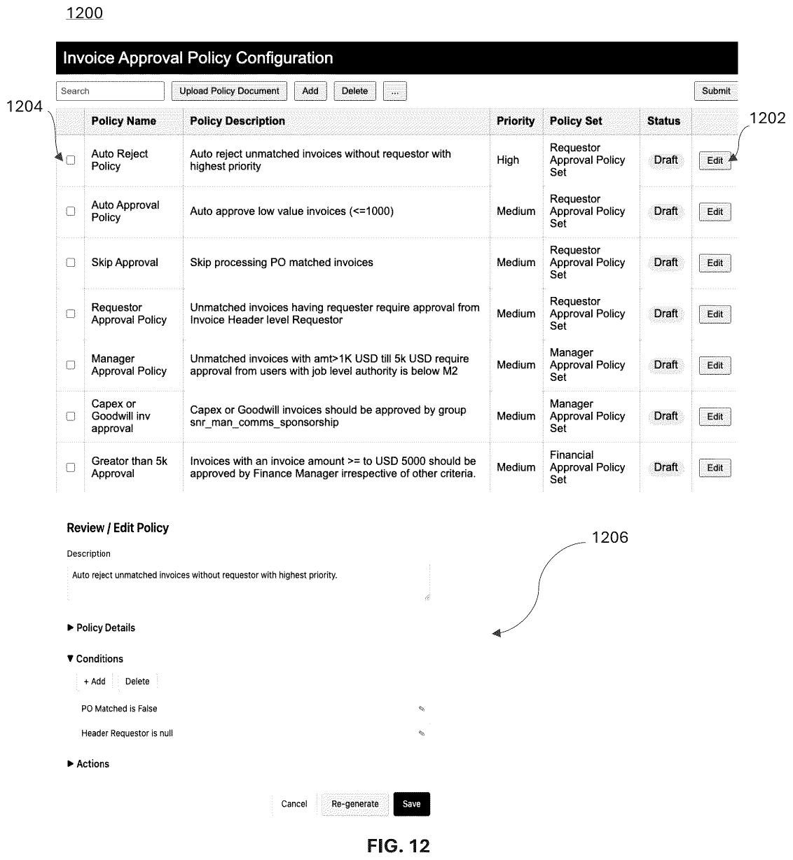

FIG. 12 illustrates an example user interfaces 1200 for uploading, adding, deleting, and review/editing single or multiple policies from a file. After a file is chosen to upload and extract the policies from the user can see and review the extracted policies from the uploaded policy document. The user can click the delete button along with checking a box 1204 corresponding to a policy name to delete a policy. The user can also edit a particular policy by clicking the edit button 1202 for a corresponding policy. After this, the review/edit policy interface 1206 may appear to edit the description field, and add or delete, for example, the conditions associated with that policy. The user can then save the changes made to the policy through the save button. Additionally, the user can select the policies to submit by checking the box (e.g., 1204) or boxes corresponding with a policy name (e.g., Auto Reject Policy) or policies and clicking the submit button. In this way, the user can submit one or more policies depending on how many boxes are checked. The LLM can generate all the conditions and actions for all the policies corresponding to a checked box (e.g., 1204) once the submit button is clicked on. By providing a user interface as shown in FIG. 12, the user can add, edit, and delete multiple policies and submit multiple policies to the LLM.

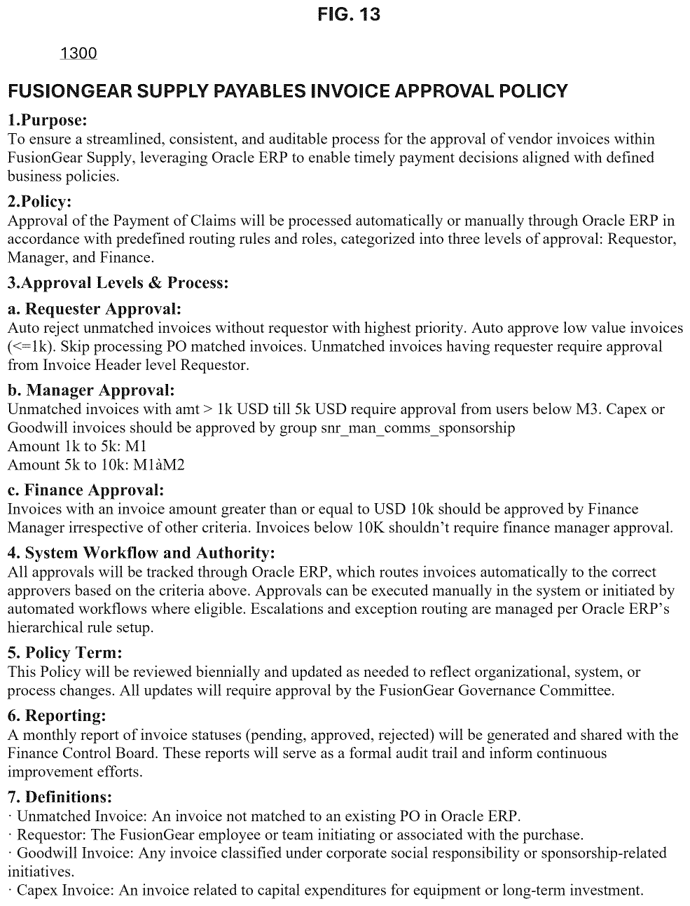

FIG. 13 illustrates an example text file of a policy document 1300. A user interface may be used to upload this policy document 1300 containing multiple policies. In an embodiment, the policy document may be a single document (e.g., word processing document) that includes multiple policies. After inputting the policies into the LLM, the LLM will generate all the conditions and actions for all the policies provided in the policy document (e.g., a single word processing document). This allows the user to easily provide multiple polies through a first-time creation word document or policy document 1300 as shown, for example, in FIG. 13.

### 5. Computer Networks and Cloud Networks

In some embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread). A link that connects overlay nodes is implemented as a tunnel through the underlying network. The overlay nodes at either end of the tunnel treat the underlying multi-hop path between them as a single logical link. Tunneling is performed through encapsulation and decapsulation.

In some embodiments, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In some embodiments, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In some embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In some embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In some embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In some embodiments, in a multi-tenant computer network, tenant isolation is implemented to ensure that the applications and/or data of different tenants are not shared with each other. Various tenant isolation approaches may be used.

In some embodiments, each tenant is associated with a tenant ID. Each network resource of the multi-tenant computer network is tagged with a tenant ID. A tenant is permitted access to a particular network resource only if the tenant and the particular network resources are associated with a same tenant ID.

In some embodiments, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In some embodiments, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In some embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

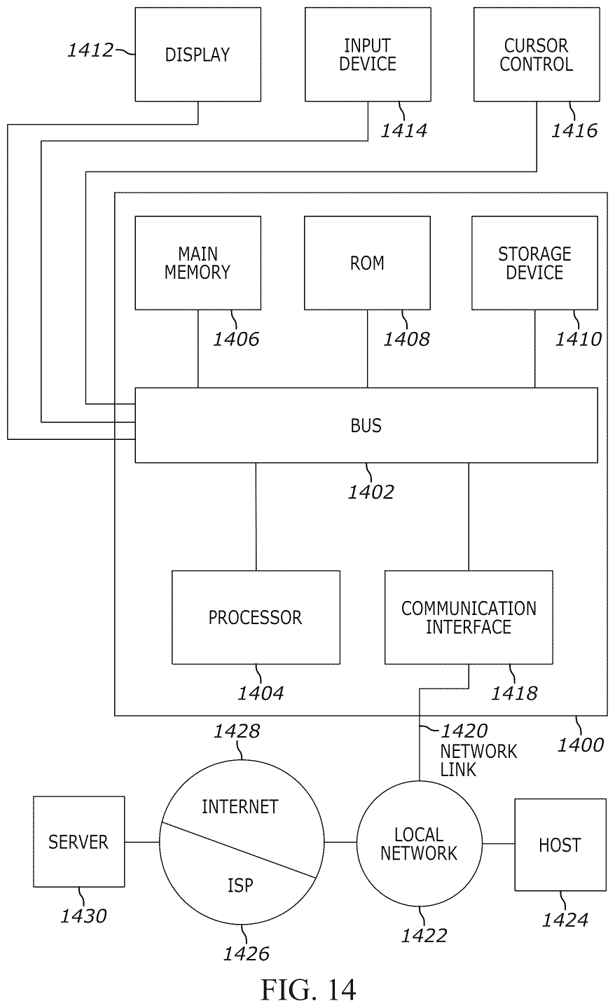

For example, FIG. 14 is a block diagram that illustrates computer system 1400 upon which some embodiments of the invention may be implemented. Computer system 1400 includes bus 1402 and/or one or more other communication mechanisms for transferring data between system components. Computer system 1400 also includes hardware processor 1404 coupled with bus 1402 for processing information. Hardware processor 1404 may be, for example, a general-purpose microprocessor.

Computer system 1400 further includes main memory 1406, such as random-access memory (RAM) and/or other dynamic storage devices, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 into a special-purpose machine that is customized to perform the operations specified in the instructions.

Computer system 1400 further includes a read only memory (ROM) 1408 and/or other static storage device coupled to bus 1402 for storing static information and instructions for processor 1404. Storage device 1410, such as a magnetic disk or optical disk, is provided and coupled to bus 1402 for storing information and instructions.

Computer system 1400 may be coupled via bus 1402 to display 1412, such as a cathode ray tube (CRT) or light-emitting diode (LED) screen, for displaying information to a computer user. Input device 1414, including alphanumeric and other keys, is coupled to bus 1402 for communicating information and command selections to processor 1404. Another type of user input device is cursor control 1416, such as a touchscreen, mouse, a trackball, or cursor direction keys for communicating direction information and command selections to processor 1404 and for controlling cursor movement on display 1412. This input device may have two degrees of freedom in two axes, a first axis (e.g., x) and a second axis (e.g., y), that allows the device to specify positions in a plane.

Computer system 1400 may implement the techniques described herein using customized hard-wired logic, one or more ASICs or FPGAs, firmware and/or program logic which in combination with the computer system causes or programs computer system 1400 to be a special-purpose machine. According to one embodiment, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1410. Volatile media includes dynamic memory, such as main memory 1406. Common forms of storage media include, for example, a floppy disk, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1402. Transmission media can also take the form of acoustic or light waves, such as those generated during radio-wave and infra-red data communications.

Various forms of media may be involved in carrying one or more sequences of one or more instructions to processor 1404 for execution. For example, the instructions may initially be carried on a magnetic disk or solid state drive of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes communication interface 1418 coupled to bus 1402. Communication interface 1418 provides a two-way data communication coupling to network link 1420 that is connected to local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic or optical signals that carry digital data streams representing various types of information.

Network link 1420 typically provides data communication through one or more networks to other data devices. For example, network link 1420 may provide a connection through local network 1422 to host computer 1424 or to data equipment operated by Internet Service Provider (ISP) 1426. ISP 1426 in turn provides data communication services through the worldwide packet data communication network now commonly referred to as the “Internet” 1428. Local network 1422 and Internet 1428 both use electrical, electromagnetic or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410, or other non-volatile storage for later execution.

In an embodiment, a computer system, such as computer system 1400, includes one or more hardware processors (e.g., 1404). The computer system also includes one or more non-transitory computer-readable media (e.g., main memory 1406, ROM 1408, or storage device 1410) storing instructions that, when executed by the one or more hardware processors, cause the system to perform operations. These operations include retrieving supplementary information relevant to at least one of the workflow and the natural language query or policy document, the supplementary information including at least one code fragment. The operations further include building an input prompt for a large language model (LLM), the input prompt including the natural language query or policy document and the supplementary information, the input prompt also directing the large language model (LLM) to generate, based at least in part on the at least one code fragment, code that is executable to implement the policy for the workflow.

### 7. Miscellaneous; Extensions

Embodiments may be directed to a system with one or more devices that include a hardware processor and that are configured to perform any of the operations described herein and/or recited in any of the claims below.

In some embodiments, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. At least one non-transitory computer readable media storing instructions that, when executed by one or more hardware processors, causes performance of operations comprising:
receiving a natural language query defining a policy for a workflow;
retrieving supplementary information relevant to at least one of the workflow and the natural language query, the supplementary information including at least one code fragment; and
building an input prompt for a large language model, the input prompt including the natural language query and the supplementary information, the input prompt directing the large language model to generate, based at least in part on the at least one code fragment, code that is executable to implement the policy for the workflow.

2. The at least one non-transitory computer readable media of claim 1, wherein the performed operations comprise receiving a prompt template, and populating the prompt template using the supplementary information.

3. The at least one non-transitory computer readable media of claim 1,
wherein the performed operations comprise encoding a numerical representation of the natural language query using an embedding model, and
wherein retrieving the supplementary information comprises retrieving the at least one code fragment from a database of code fragments encoded in the numerical representation based on a similarity threshold.

4. The one or more non-transitory computer readable media of claim 3,
wherein the numerical representation comprises a vector representation, and
wherein the similarity threshold comprises a Euclidean distance threshold value so that the at least one code fragment from the database is retrieved as supplementary information when the Euclidean distance between the vector representation of the natural language query and the vector representation of the at least one code fragment is less than the threshold value.

5. The at least one non-transitory computer readable media of claim 3, wherein the at least one code fragment comprises a condition rule fragment and an action rule fragment.

6. The at least one non-transitory computer readable media of claim 5,
wherein the condition rule fragment is retrieved using a condition driver defined with functional context to interpret a condition on a business object and a correct attribute, and
wherein the action rule fragment is retrieved using an action driver to interpret the action taken after the condition is satisfied.

7. The at least one non-transitory computer readable media of claim 1,
wherein the at least one code fragment conforms to a JavaScript Object Notation (JSON) schema.

8. The at least one non-transitory computer readable media of claim 1,
wherein the retrieving of the supplementary information comprises using a schema driver to select a particular schema from a plurality of schemas,
wherein the code fragment follows the particular schema, and
wherein the input prompt directs the large language model to generate the code to implement the policy according to the particular schema.

9. The one or more non-transitory computer readable media of claim 1, wherein retrieving the supplementary information comprises:
retrieving at least one text file comprising contextual information; and
retrieving a prompt template related to the workflow.

10. The one or more non-transitory computer readable media of claim 9, wherein the performed operations comprise:
populating the prompt template with the contextual information from the at least one text file;
populating the prompt template with the natural language query;
populating the prompt template with general instructions related to the workflow;
populating the prompt template with an output structure defining the schema for a rule generated by a large language model; and
populating the prompt template with domain knowledge independent of the workflow, and
wherein the supplementary information includes domain knowledge.

11. The at least one non-transitory computer readable media of claim 1, wherein the supplementary information comprises:
contextual information;
at least one condition rule fragment;
at least on action rule fragment;
domain knowledge;
general instructions; and
a schema.

12. The at least one non-transitory computer readable media of claim 11, wherein building the input prompt comprises combining the natural language query and the supplementary information.

13. The at least one non-transitory computer readable media of claim 1, wherein the performed operations comprise:
receiving a response from the large language model that includes the code for implementing the policy for the workflow; and
integrating the code for implementing the policy for the workflow into one or more software applications.

14. The at least one non-transitory computer readable media of claim 1, wherein the performed operations comprise:
receiving a response from the large language model that includes the code for implementing the policy for the workflow;
performing post-processing on the code to check for a missing attribute; and
responsive to determining that an attribute is missing, refining the code to correct for the missing attribute.

15. The at least one non-transitory computer readable media of claim 14, wherein correcting for the missing attribute comprises using a default attribute for the missing attribute.

16. The at least one non-transitory computer readable media of claim 14, wherein correcting for the missing attribute comprises sending the rule back to the large language model for the large language model to provide the missing attribute or refine the rule so the attribute is not needed.

17. The at least one non-transitory computer readable media of claim 1, wherein the performed operations comprise performing a validation process on the code to determine if the code satisfies validation criteria.

18. The at least one non-transitory computer readable media of claim 17,
wherein the performed operations comprise:
iteratively sending the code back to the large language model for the large language model to refine the code; and
publish the code responsive to determining that the code satisfies the validation criteria.

19. A method comprising:
receiving a natural language query defining a policy for a workflow;
retrieving supplementary information relevant to at least one of the workflow and the natural language query, the supplementary information including at least one code fragment; and
building an input prompt for a large language model, the input prompt including the natural language query and the supplementary information, the input prompt directing the large language model to generate, based at least in part on the at least one code fragment, code that is executable to implement the policy for the workflow.

20. A system comprising:
one or more hardware processors;
one or more non-transitory computer-readable media storing instructions that, when executed by the one or more hardware processors, cause the system to perform operations comprising:
receiving a natural language query defining a policy for a workflow;
retrieving supplementary information relevant to at least one of the workflow and the natural language query, the supplementary information including at least one code fragment; and
building an input prompt for a large language model, the input prompt including the natural language query and the supplementary information, the input prompt directing the large language model to generate, based at least in part on the at least one code fragment, code that is executable to implement the policy for the workflow.
